(19) United States
(12) Patent Application Publication
(10) Pub. No.: US 2025/0187066 A1
(43) Pub. Date: Jun. 12, 2025

(54) STEEL PLANT WITH DIRECT COOLING WATER TREATMENT CIRCUIT AND RELATED PROCESS

(71) Applicant: DANIELI & C. OFFICINE MECCANICHE S.P.A., Buttrio (UD) (IT)

(72) Inventors: Antonio NARDELLA, Greve in Chianti (FI) (IT); Massimo FABIANI, Buttrio (UD) (IT)

(21) Appl. No.: 18/843,081

(22) PCT Filed: Feb. 28, 2023
(86) PCT No.: PCT/IB2023/051836

§ 371 Date: Aug. 30, 2024

(30) Foreign Application Priority Data
Mar. 1, 2022 (IT) 102022000003797

(51) Int. Cl. B22D 11/124; C02F 1/00; C02F 1/40; C02F 9/00; C02F 101/32; C02F 103/16

(52) U.S. Cl. CPC B22D 11/1246; C02F 9/00; C02F 1/004; C02F 2001/007; C02F 1/40; C02F 2101/32; C02F 2103/16; C02F 2303/22

(57) ABSTRACT

The invention concerns a steel plant for the production of long or flat products with a treatment circuit of water deriving from direct cooling and a relative process that envisage that the cooling waters coming from first machinery that produce cooling waters less loaded with scale (with a low content of suspended solids), as quenching units, directly feed second machinery producing cooling waters rich in scale, such as rolling mills, preferably by first passing through at least one collecting tank to then be treated in a succession of water treatment devices such as scale pits, clarifiers, filters and cooling towers to feed the first machinery again.

### TECHNICAL FIELD

The present invention refers to a steel plant for the production of long products, in particular bars, rods, profiles, wires and the like, or for flat products, in particular strips, sheets and the like comprising:
(a) a plurality of machinery equipped with direct cooling systems, divided into at least a first and a second group of machinery, each group comprising one or more machinery, wherein the groups of machinery are distinguished by the different higher or lower concentration of scale released into the cooling water accumulated during use of each group of machinery;
(b) a circuit of treatment of direct cooling waters exiting said direct cooling systems, comprising a plurality of cooling water treatment devices.

### STATE OF THE ART

Steel plants for the production of flat and long products generally provide, upstream of the rolling line, a continuous casting machine or a plate for loading material to be rolled, followed by a descaler, an emergency shear, preferably a reheating furnace, a further emergency cutting device, optionally another descaler, roughing cages, another shear, a possible further reheating furnace, for example an induction one, an intensive or accelerated cooling device and a further descaler, pre-finishing and/or finishing cages, a laminar cooling device, a further shear for cutting to size the rolled product and then winders for the products to be wound, or discharge plates for the bars or a coil-shaping head and a conveyor belt for the rod. Along the line, coolings are necessary, for example for the product, the parts of the devices used, the rolling rolls, etc., which can be made by direct coolings or indirect coolings.

Direct cooling is for example applied in rolling and in pre-finishing of a metal product and can involve detaching oxides from the product, called scale, which in general at this phase of processing has large dimensions, other direct coolings are carried out in the finishing and quenching of the rolled product, and the detachment in water of a finer scale takes place, being the temperatures lower and a larger scale detachment having already occurred upstream. The cooling waters accumulate under the machinery and drag the scale coming from the rolling, reheatings and accessory processings, thus assuming different characteristics in terms of quantity/concentration and dimensions of the contained scale. Scale concentrations in the waters also depend on the volume of waters used and the quantity of scale produced. For example, in flat products, which use a lot of water (in the order of magnitude of several thousand m³/h), the average scale concentration will be lower than in the rolling plants for long products, which on the contrary use less water for the different cooling phases.

Usually cooling plants in a steel plant for the production of flat products, such as direct quenching or the accelerated cooling in the rolling mills or laminar cooling have a dedicated water treatment plant (Water Treatment Plant, WTP) in order to treat and cool the water, and return it to the cooling systems. This circuit is separate from the main circuit that feeds the rest of the line. The demand for water from such cooling systems is generally intermittent depending on the cooling phases that the product has to undergo. The accelerated cooling circuit and the side spray units produce less dirty waters, while the rolling mills, the descalers and the reheating furnaces produce greater quantities of scale in the water.

By long products are generally meant rods, wires, bars and profiles. The cast products or those loaded via the plate are rolled and undergo high reductions and intermediate reheatings, leading, during direct cooling in the different phases, to the detachment of high quantities of scale compared to flat products, which, using a lot of water, have a greater dilution capacity.

In steel plants for the production of long products, usually, the flows coming from quench cooling systems are sent to the WTP to treat and cool the water and this takes place in parallel with the water flows coming from the rolling mills. This means that WTP must treat the sum of the flow rates coming from quenching, rolling and finishing and therefore must be oversized in terms of the size of the treatment units.

The WTP of any steel plant mainly requires the following treatment/cooling sections: collecting tanks, pumping stations and pump room, sand filters and relative sludge treatment, cooling towers, civil works and relative buildings, electrical and automation devices and plants, pipings, and in specific cases units for dosing chemicals.

The steel plants referred to above provide for separate water treatment circuits (production of flat products) for machinery producing more or less dirty waters to adapt the treatment to the needs or scale content or a circuit that treats together (production of long products) all the waters deriving from the machinery, regardless of whether these machineries produce waters that are lean or rich in scales, this results in high costs and extensive and complex circuits and in the need for a large number of cooling water treatment devices.

The expense in terms of devices needed to treat the waters is considerable, on the one hand for the large quantities of waters to be filtered and purified, on the other hand to have to provide for more than one circuit to treat the waters differently charged with scales, an expense that results in a significant increase in the capacity and/or number of water treatment devices. This need has a negative impact on OPEX and CAPEX values. OPEX is the operating expense, which stands for Operating Expense, i.e. the cost necessary to manage a product, business or system. Its counterpart, CAPEX (which stands for Capital Expenditure), is the cost to install, develop or provide durable assets for the product or the system.

### SUMMARY OF THE INVENTION

The invention aims to overcome the above drawbacks and to propose a steel plant as initially defined which is less complex, which simplifies the direct cooling water treatment circuit(s), which requires less water and reduces the apparatus necessary to separate the scale from the cooling waters. Further objects or advantages of the invention will result from the following description.

In a first aspect of the invention, the object is achieved by a steel plant as initially defined which is characterized in that
(i) said direct cooling systems of said two groups of machinery are connected in series, wherein said direct cooling systems of said second group of machinery producing cooling waters with a higher scale concentration are situated downstream of said direct cooling systems of the first group of machinery producing cooling waters with a lower scale concentration, so that said direct cooling systems of said first group of machinery feed said direct cooling systems of said second group of machinery; and in that
(ii) said direct cooling water treatment circuit is arranged downstream of said second group of machinery.

The connection in series reduces the quantity of water needed to cool all machinery as the second group of machinery uses the same cooling water exiting the first group of machinery. This makes it possible to reduce the water treatment devices as the volume of the cooling water has been reduced and is to be cleaned only after leaving the second group of machinery. The inventors have therefore, deviating from the traditional way, identified the opportunity to send the cooling water exiting the first group of machinery directly, i.e. preferably without particular purification and cooling, in the second group of machinery, a connection in series made possible also by the fact that the flow rates of both groups of machinery are comparable. This applies to the production of long products and to the production of flat products.

The optimization proposed by the invention therefore consists in the possibility of directly reusing the water discharged from the sections of the machinery of the first group, for example quenching machinery, in other users, for example rolling mills. These downstream users require a certain water quality and an inlet temperature that the water exiting the first group of machinery satisfies.

In a preferred embodiment of the invention, between said direct cooling systems of said first group and said direct cooling systems of said second group at least one collecting tank is provided along the water flow. The collecting tank allows to compensate for any hydraulic imbalances in the management in series of the two groups of machinery and to take over in the moments of machine downtime or flow rates that are not always completely compatible between the two groups and can be filled not only by the first group of machinery, but also by other sources.

Advantageously, the cleaning of the cooling waters exiting the second group of machinery takes place in the water treatment circuit, in particular realized as a single circuit, which comprises a succession of water treatment devices. In this regard, the cooling water treatment circuit arranged downstream of said second group of machinery comprises a succession of water treatment devices, in turn, comprising, in the following order, at least one tank, preferably at least two tanks for separating scale and/or oil, said tank(s) preferably being divided into several chambers separated by means of one or more weirs, at least one filter unit and at least one cooling tower provided with at least one tank for collecting cooled water and connected to said direct cooling systems of said first group of machinery and/or, if present, to said at least one collecting tank. The cooled water collecting tank can also feed any descaler or continuous casting machinery and relative sprayers present in the steel plant or other users.

The number of the single elements of the circuit may vary, such as the number of the cooling towers, and additional water treatment devices may be integrated. For separating scale, different devices can be envisaged in the relative tanks, such as buckets or magnetic devices that collect the settled scale, scrapers or dredging conveyors, lamellar filters. These systems, as well as the suitable oil separators, are well known to the person skilled in the art. The tank for separating scale and oil is usually oblong in extension. It is also conceivable to replace mentioned elements with others, for example other types of tanks for separating scale.

A first tank could be a simple scale pit, and a second tank an oblong clarifier with two chambers.

In a preferred embodiment of the invention, said steel plant is a plant for the production of long products, in particular bars, rods, profiles, wires and the like wherein the first group comprises at least one piece of machinery selected from the group consisting of quenching units and tempering units and that said second group comprises at least one piece of machinery selected from the group consisting of fast finishing blocks, rolling mills and reheating furnaces. In the case of steel plants for the production of long products it has proved to be preferable that said collecting tank also feeds the at least one scale and/or oil separation tank, in particular a second scale and/or oil separation tank, preferably the most downstream chamber of the tank. This can be useful for managing the hydraulic conditions of the system and avoids scale and oil removal processes where not necessary.

In another preferred embodiment of the invention, said steel plant is a plant for the production of flat products, in particular strips, sheets and the like and said first group of machinery comprises at least one piece of machinery selected from the group consisting of accelerated cooling units, side sweep spray units, direct quenching units, laminar cooling units and that said second group of machinery comprises at least one piece of machinery selected from the group consisting of hot rolling mills and reheating furnaces.

Advantageously, descalers and continuous casting machinery are not directly fed by the first group, but only from clean waters in respective water treatment devices after passing the second group of machinery.

Advantageously, the machinery of said second group are therefore suitable for use in the direct cooling system, without affecting the quality of the product that produce, during use, the waters coming from said cooling systems of said first group of machinery that therefore have characteristics suitable to be able to feed the second group of machinery. Suitable characteristics concern the total suspended solids content, the inlet temperature and the oil and grease content.

A second aspect of the invention refers to a process for treating direct cooling waters of a steel plant for the production of long products, in particular bars, rods, profiles, wires and the like, or for flat products, in particular strips, sheets and the like, comprising the following steps:
(I) performing direct cooling in the steel plant resulting in the production of cooling waters rich in scale content and cooling waters less loaded with scale, depending on the machinery which make up said steel plant, which are divided into at least two groups of machinery depending on the scale content present, i.e. released from the product processed by said groups of machinery into the cooling water;
(II) conveying the heated cooling waters with a lower scale content exiting the respective first group of machinery to the second group of machinery of the plant that produce waters rich in scale, preferably by intermediate storage in a collecting tank;
(III) purification of the cooling water heated and contaminated by the second group of machinery in a succession of water treatment devices comprising in the following order at least one tank, preferably at least two scale and/or oil separation tanks, at least one filtration unit and at least one cooling tower, wherein preferably under wet bulb conditions <26° C., the water is cooled to or below 30° C.;
(IV) reintroduction, at least partially, of the waters cleaned and cooled during step (III) into the direct cooling systems of said first group of machinery and/or into said collecting tank, if any.

To define whether a machinery belongs to the first or second group of machinery, the content of total suspended solids expressed in mg/l or ppm of the cooling water exiting the machinery is advantageously assessed. Preferably, the scale lean waters comprises total suspended solids ≤70 mg/l, preferably from 20 to 60 mg/l, in the case of a steel plant for the production of long products, and ≤50 mg/l, preferably from 5 to 20 mg/l, in the case of a steel plant for the production of flat products. The total suspended solids content is preferably determined according to the Standard Method (Standard Methods) SM 2540 D (Determination of Total Suspended Solids) accessible for example on the website www.standardmethods.org. The standard deviation to be considered in determining the values is 2.8 mg/l.

Preferably, the waters to be transferred to the machinery of the second group contain for both types of steel plants only traces of oils and/or greases therefore the relative machinery of the first group preferably produce waters with only traces of oils and/or greases, quantifiable in ≤2 mg/l. The oils and greases content is preferably determined according to the standard method (Standard Methods) SM 5520 B (Determination of Oil and Grease) accessible for example on the website www.standardmethods.org. The standard deviation to be considered in determining the values is 0.2 mg/l.

These values are not to be understood as an aim to be achieved by the individual machinery, but they are values that occur during normal use of the machinery and allow their division into a first and a second group of machinery according to the invention.

Advantageously, the waters exiting the first group of machinery have a ΔT with respect to the inlet temperature required by the second group of machinery which corresponds to ≤8° C. in the case of a steel plant for the production of long products and a ΔT of ≤5° C. in the case of a steel plant for the production of flat products. For long products, between a classic plant and the plant according to the invention the inlet temperature in the second group of machinery can increase for example from 35° C. to 43° C.; while increases from 30° C. to 33.5° C. are for example observed for flat products.

The above shown values are respected by the machinery that make up the first group. Therefore, there are no particular contraindications in reusing the cooling water used in them in the users that make up the second group of machinery. The solution according to the invention, optimized with respect to the state of the art, allows to reduce the flow rates of the cooling towers by about 40%, to almost halve the number of sand filters or self-cleaning filters and to reduce by about 20% the size of any sludge thickeners used in connection with the filter units. In addition, reductions in the powers of the pumps, piping lengths/diameters, number of pumps, size of the tanks and pump room are feasible.

Compared to the state of the art, where the waters used in the second group of machinery are purified and cooled waters, the water for the users within the second group, such as rolling mills, in terms of TSS (for long products on average from 30 to 70 mg/l) compared to the quality of the circulating water in the classic solution (containing TSS <50 mg/l) may have a lower quality which is however acceptable. In a preferred embodiment of the invention, this phenomenon can be mitigated by applying more wear and clogging resistant spray nozzles to the cages of the rolling mill. The increase in water temperature for the users of the rolling mill (for example 43° C.) compared to the temperature of the circulating water in the classical solution (for example 35° C.) in the production of long products, can be mitigated, in case of wet bulb values below certain thresholds, by cooling the water to suitable temperatures. For example: when the wet bulb is <26° C., it is possible to cool the water to or below 30° C., consequently the water temperature for the users of the rolling mill will have increased only to 38° C., in the case of the chosen example. The greater complexity in the hydraulic balance of the management in series is manageable with a control unit that controls the various flow rates. The savings in terms of CAPEX and OPEX are important, too. In the case of the invention, relatively to a steel plant for the production of long products, CAPEX sees savings in relation to the electro-mechanical equipment, civil works, installation activities. Also in terms of OPEX savings can be noted for energy, chemicals and water/sludge conditioning.

The invention has significantly optimized the water treatment plant for the production of long and flat products in terms of CAPEX and OPEX, reusing the water discharged from the first group of machinery (e.g. from accelerated cooling and direct quenching) directly into the direct cooling users in the second group of machinery (e.g. rolling mills), and this without any dedicated WTP for each group of machinery. The principle is applicable to many types of plants: to rolling mills of various kind, for the production of thin strips, sheets, rods, narrow strips, profiles, wires, etc. ranging within a large range of diameters, thicknesses, widths, types of section, etc.; to various types of direct cooling, such as accelerated cooling, laminar cooling; and to quenching units and tempering units of various kind.

In the case of the production of flat products, the users downstream of the first group of machinery are a little more demanding in terms of TSS and ΔT, but the machinery of the first group of machinery, such as accelerated cooling and quenching, still respect the characteristics required by usually supplying waters with a TSS between 5 and 20 ppm, only traces of oil and grease and a ΔT between 2 and 5° C. The envisaged temperature increase at the first group of machinery is generally already compensated upstream, in the WTP, without any effort considering the wet bulb temperature at the plant site.

The optimization proposed by the invention makes certain advantageous modifications to the plant: the cooling towers for the first group of machinery are eliminated, the same applies to sand filters and sludge treatment, dosing units for chemical treatments are no longer needed, while the pumping station of the classic solution can be used, but the pump room WTP is no longer needed and the collecting tanks have been resized.

Obviously, even in the case of the production of flat products, the quality of water for the users of the second group of machinery compared to the classic solution is worse in terms of TSS, but it is still an acceptable quality. The greater complexity in the hydraulic balance of the two circuits in series can be controlled by a relative control unit of the plant, and the increase in temperature at the first group of machinery is not problematic considering a suitable wet bulb temperature in the plant.

The features and advantages described for one aspect of the invention may be transferred mutatis mutandis to the other aspects of the invention.

The industrial applicability is obvious from the moment that the following situation occurs: The connection in series of the two groups of machinery manages to achieve considerable savings in terms of CAPEX and OPEX, to considerably lower the volume of cooling water required for direct cooling of all users and to reduce the space required by up to 35%. Having also reduced the number of water treatment devices, civil works and necessary maintenance are reduced, too.

The objects and advantages will be further highlighted in the description of preferred embodiment examples of the invention given by way of non-limiting example only.

Variant and further features of the invention are the subject matter of the dependent claims. The description of preferred embodiment examples of the plant and of the process according to the invention is given, by way of non-limiting example, with reference to the attached drawings. In particular, unless otherwise specified, the number, shape, size and materials of the individual components of the plant may vary, and equivalent elements may be applied without deviating from the inventive concept.

### BRIEF DESCRIPTION OF THE DRAWINGS

FIG. 1 represents in a flowchart a direct cooling water treatment plant in a steel plant for the production of flat products according to the state of the art.

FIG. 2 represents in a flowchart a direct cooling water treatment plant in a steel plant for the production of flat products according to the invention.

FIG. 3 represents in a flowchart a direct cooling water treatment plant in a steel plant for the production of long products according to the state of the art.

FIG. 4 represents in a flowchart a direct cooling water treatment plant in a steel plant for the production of long products according to the invention.

FIG. 5 represents in a flowchart a direct cooling water treatment plant for accelerated cooling, side spray and direct quenching users according to the state of the art.

FIG. 6 represents in a flowchart the direct cooling water treatment plant according to FIG. 5 modified according to the invention.

FIG. 7 represents in a flowchart the separated direct cooling water treatment circuits of a steel plant for the production of long products according to the state of the art.

FIG. 8 represents in a simplified flowchart the union of the two cooling water treatment circuits of FIG. 7 into a single circuit according to the invention.

### DETAILED DESCRIPTION

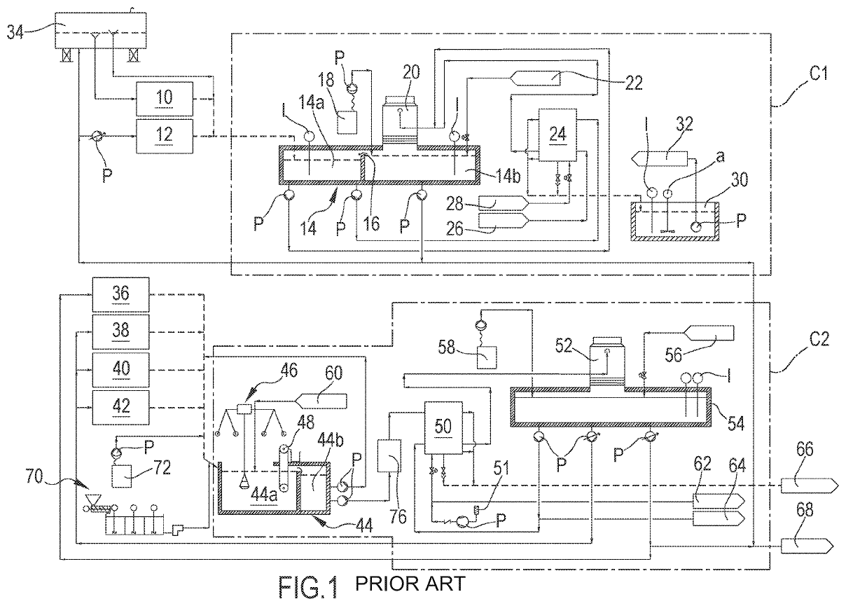

FIG. 1 represents in a flowchart a direct cooling water treatment circuit of a steel plant for the production of flat products according to the state of the art. An exemplary accelerated cooling system 10, with a flow rate of almost 5,000 m³/h and a side sweep spray unit 12 (flow rate about 100 m³/h) feeds a tank 14 divided into two chambers 14a and 14b separated by a weir 16 which transfers water from the chamber 14b to the chamber 14a. The chamber 14b is fed by a tank 18, a cooling tower 20 and a water make-up source 22. The cooling tower 20, in turn, is fed by waters deriving directly from the chamber 14a or after cleaning in a filter 24. The filter 24 is also served by washing water 26 or backwash air 28. The waste from the filter 24 is conveyed to a tank 30 from where the water is subject to drainage or backwash of a scale pit. The cooled water chamber 14b feeds only the accelerated cooling systems 10 and the side spray systems 12 (which can be fed in case of need also by a storage/distribution tank 34 which can also feed the chamber 14a) thus closing the water circuit.

In all drawings, level gauges are designated with I, pumps with p and agitators with a. The flow rates indicated below are just an example and vary with the size of the plant. The water treatment circuit includes a second part dedicated to the treatment of water deriving from hot rolling mills for the production of strips at high pressure with flow rates around 3,700 m³/h 36 or at low pressure (with flow rates about 240 m³/h) 38 and descalers (flow rate of about 350 m³/h) 40 and reheating furnaces (flow rate of about 30 m³/h) 42 which all feed a tank 44 with a first chamber 44a and a second chamber 44b, and precisely feed the first chamber 44a provided with a crane with a bucket 46 and with an oil separator 48, the surface water (freed from oil and heavy scale) overflows into the chamber 44b, from where it is pumped into a circuit again in the chamber 14a in order to be cleaned a second time or, passing through a two-chamber clarifier 76 with oil and scale separation devices (not represented) in a filter 50 which feeds a cooling tower 52 that collects the cooled water in a single-chamber tank 54. The tank can also be fed with make-up water 56 or from a tank 58 for storing and dosing conditioning chemicals, while the tank 44 can also be fed with waters coming from a sludge thickener 60. The filter 50 is manageable with backwash air 62 and washing water 64, drain water 66 is drained. The water of the tank 54 can feed the filter 50 for its backwash with clean water, the dirty water producers 38, 40 and 42 and, with a pump and line dedicated to take into consideration the large flow rate, the user 36; this line provides a blowdown system 68, also available from the line exiting from the tank 14 to feed the cooling water users 10 and 12 or the tank 34. The tank 44 can be fed by a polyelectrolyte source 70 or by a tank 72.

The plant for the production of flat products also includes a water treatment plant for water deriving from indirect cooling, waters that due to the nature of the indirect treatment (for example from reheating furnaces (flow rates about 400 m³/h)), hot strip rolling mills (flow rates about 1,300 m³/h) and electric motors (with flow rates around 215 m³/h) do not require special purifications and can be transferred directly to a cooling tower (equipped with a water make-up service well known to the person skilled in the art, where necessary with filters and brine pits). These indirect cooling waters are not covered by the invention.

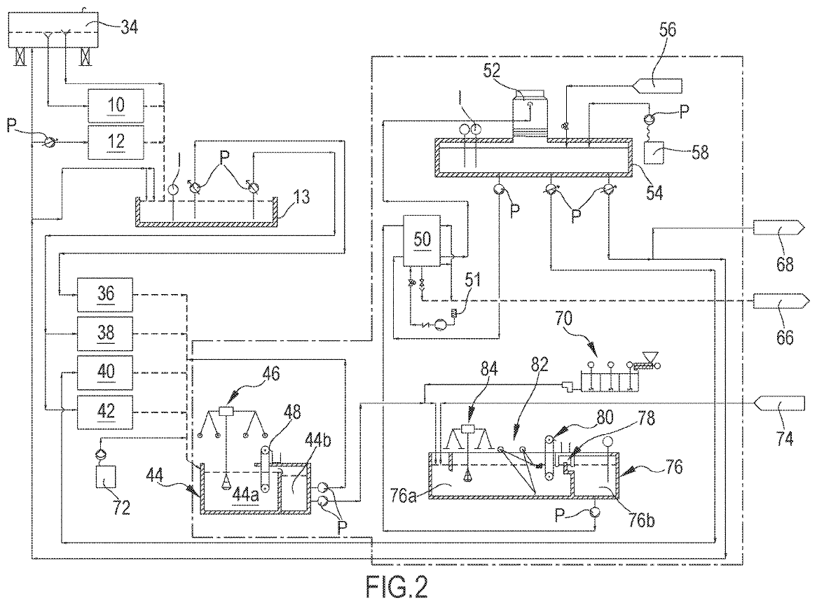

For the different dirty water producers or cooling water users, two distinct cooling circuits C1 and C2 can be noted, while the invention combines the circuits into a single circuit C putting in series the two groups of producers (10, 12 and 36, 38, 40 and 42), as represented in FIG. 2.

FIG. 2 represents in a flowchart a direct cooling water treatment plant of a steel plant for the production of flat products according to the invention. The elements corresponding to those of the state of the art, as represented in FIG. 1, have the same reference numbers. The sources of heated and contaminated cooling water 10 and 12 no longer directly feed a cooling tower with a double tank and filter system (14 and 20) as represented in FIG. 1, but they feed a collecting tank 13 from which they reach with different pumps, depending on the required flow rate, the previously illustrated cooling water users 36 (with a flow rate of about 3,700 m³/h), 38 and 42 (with a flow rate of about 270 m³/h), while the user 40 is fed differently (with a flow rate of about 1,000 m³/h), as will be illustrated below. From the heated direct cooling water sources 36, 38, 40 and 42, the dirty and heated water reaches the bucket system 46 and oil separator 48 with relative tank 44 like in the state of the art (FIG. 1). The water exiting the coarse purification in the tank 44, before being conveyed to a sand filter and to a cooling tower (50 and 52), crosses a longitudinal tank 76 with two chambers 76a and 76b. The first tank 76a envisages the sedimentation of scale and its removal with a bucket 84, a scraper 82 and an oil separator 80 and can be integrated with an addition of polyelectrolyte 70, the water thus cleaned passes through a weir 78 in the chamber 76b, from where it reaches the sand filter system 50 and the cooling tower 52 with a single tank 54 already known from the state of the art (FIG. 1). Make-up 56, drainage 66 and blowdown 68 systems correspond to what is known from the state of the art. From the tank 54 the cooled waters can feed the filter 50 for the backwash thereof with clean water, the user 40 or the collecting tank 13, the user 12 or the storage/distribution tank 34.

The drainage water 60 after an appropriate treatment can return to the tank 76, this treatment involves a collection in a tank from which it is conveyed in a sludge thickener from which it is always introduced into the tank 76 or through a passage through a further tank it continues in a drainage system to eliminate the sludge that must be taken to the landfill. Additives can be added to the thickener or to the drainage or dehydration system (dewatering unit). This part of the plant is well known to the expert and is not illustrated in more detail. The quality, the flow rate and the temperature of the water exiting the users 10 and 12 is therefore suitable for distribution among the users 36, 38, 40 and 42.

The tanks 13, 34 and 44 and their connections allow compensating for any flow rate imbalances in feeding the users. The inlet temperatures in the users 36, 38, 40 and 42 are little influenced by the passage from the classic version to the invention.

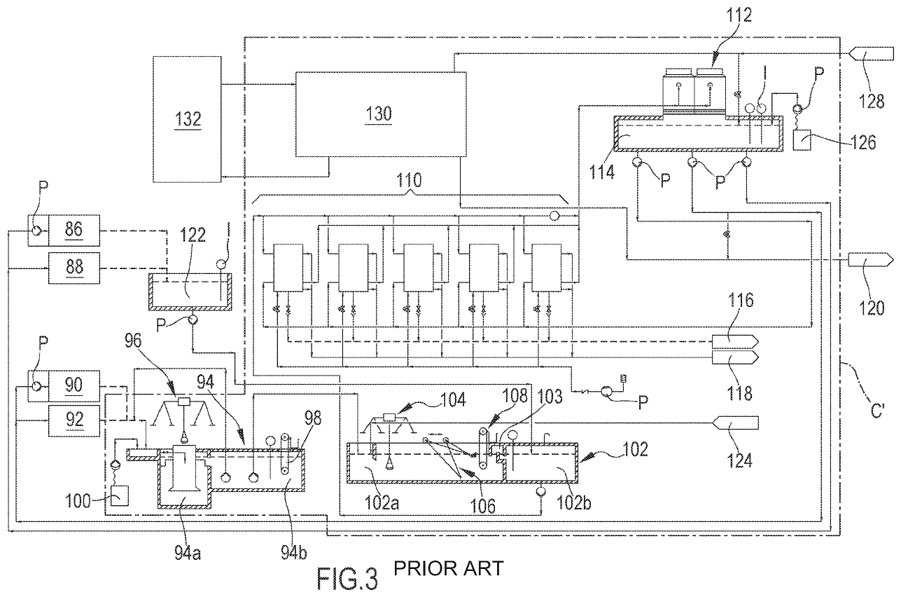

FIG. 3 represents in a flowchart a direct cooling water treatment plant of a steel plant for the production of long products according to the state of the art. The quenching 86 and tempering 88 units and those of the fast-finishing block 90 and of the rolling mill and of the reheating furnace 92 are the direct cooling water users in a steel plant for the production of long products. The waters exiting from the units 90 and 92 are treated in a tank 94 consisting of two chambers 94a and 94b. In the first chamber 94a the largest scale is removed with a bucket 96, while the water freed of this scale enters the chamber 94b where it is freed of oil with an oil separator 98. From the chamber 94b the water can be returned to the chamber 94a for flushing the scale in the conveying channel. A tank 100 is used to store and dose a de-oiling product. From the chamber 94b the clean water is conveyed into a longitudinal tank 102 divided into a first chamber 102a and a second chamber 102b, separated by a weir 103. In the first chamber 102a there are a bucket 104 for removing scales, a scraper 106 and an oil separator 108. The clean water exits the second chamber 102b and passes through a battery of sand filters 110 to reach after filtration two cooling towers 112 that collect the cooled water in a single tank 114. The battery of filters 110 envisages a drainage 116 and a backwash system 118. The cooled water collected in the tank 114 leaves the same to be conveyed into the battery of filters 110 for the purpose of backwashing the filters, to close the cycle to the users 90 and 92 or to be dedicated to a discharge/a blowdown 120 or to reach the other two direct cooling elements 86 and 88 that discharge their dirty and heated cooling water into a collecting tank 122 that directs the water into the chamber 102b of the longitudinal tank 102 from where it travels along the path already described. The tank 102 can also be supplied by water from a sludge thickener 124 provided in other parts of the plant. The tank 114 can receive conditioning chemicals from a tank 126 or from a make-up water source 128 that also feeds the indirect cooling water cooling plant 130 not detailed of the plant for the production of long products. This cooling plant 130 is situated in a circuit with indirect cooling users, such as rolling mills and reheating furnaces etc. 132 without special purification units.

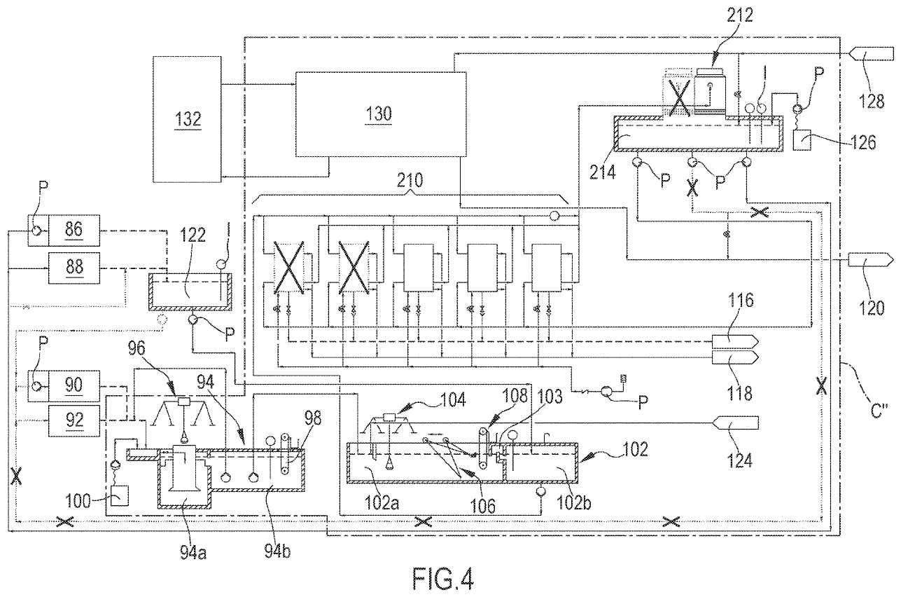

The flow rates of the users 86, 88, 90 and 92 are by way of example respectively 700-1300 m³/h, 600 m³/h, about 270 m³/h and 600 m³/h and the inlet temperature Tᵢ is about 35° C. FIG. 4 represents in a flowchart a direct cooling water treatment plant of a steel plant for the production of long products according to the invention. In contrast to the state of the art (FIG. 3), it can be immediately noted that the two cooling towers are replaced with only one 212, which also allows to reduce the volume of the respective tank 214. Also missing is the line with relative pump that leads from the tank 214, which in the state of the art, was used to supply the users 90 and 92, which in the example represented, instead, are fed directly from the tank 122, which now partly supplies the users 90 and 92 and the tank 102 which will then lead to feeding the users 86 and 88. The reduction of the quantity of water that then reaches the tank 102 and the subsequent cleaning units allows to reduce the number of filters inside the battery of the filters 210. The water that derives from the cooling tower 212 now no longer feeds the users 90 and 92, but in addition to the users 86 and 88 also directly the tank 122 to compensate for any deficit due to deficiencies of the quantity deriving from the direct passage from 86 and 88 to 90 and 92. The variations with respect to the plant represented in FIG. 3 have been highlighted with dotted lines and in the case of cancellations of individual elements of the plant also with crosses.

The example of the state of the art (FIG. 3) and of the invention (FIG. 4) always comprise a single water circuit, respectively C′ and C″, but the two groups of users 86, 88 and 90, 92 do not reach separately the same longitudinal tank 102, and from there the battery of filters 110 or 210 and cooling tower(s) 112 and 212, but are first connected in series. The flow from the tank 122 to the users 90 and 92 is about 870 m³/h, while the flow to the tank 102b is reduced by about a third. In this variant of the invention, instead, the inlet temperature Tᵢ for the users 90 and 92 increases from 35° C. to 43° C.

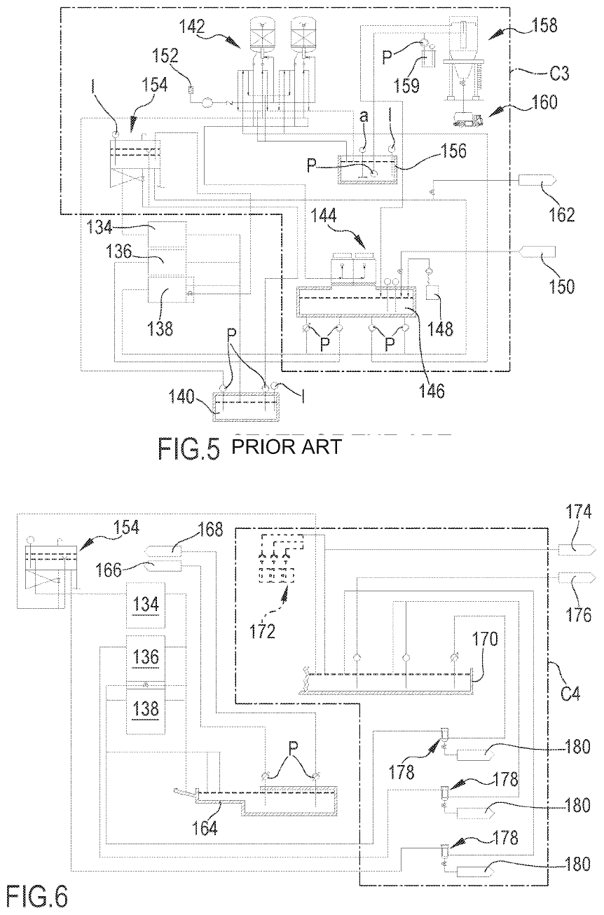

FIG. 5 represents in a flowchart a direct cooling water treatment plant for accelerated cooling 134, side spray 136 and direct quenching 138 users. The three cooling water users discharge the dirty and heated water into a tank 140 that is connected to a double cooling tower 144 with a single-chamber tank 146 that can be fed by a chemical dispenser 148 and by make-up water 150 and to a battery of filters 142. The water contained in the tank 146 can be pumped through relative pumps p directly to the user 138 or to the user 136, to the battery of sand filters 146 equipped with an air blower 152 for cleaning them or a storage and distribution tank 154 which, in turn, feeds the user 134 and the tank 146 of the cooling towers 144. The backwash water treated in the filters 142 reaches a collecting tank 156 which sends the water to a sludge thickener 158, equipped with a chemical dispenser 159, and which discharges the sludge to a truck 160 or other waste disposal means, while discharging the water that is exiting the thickening into the tank 146 of the cooling towers 144. The line connecting the tank 146 to the storage and distribution tank 154 is equipped with a blowdown system 162.

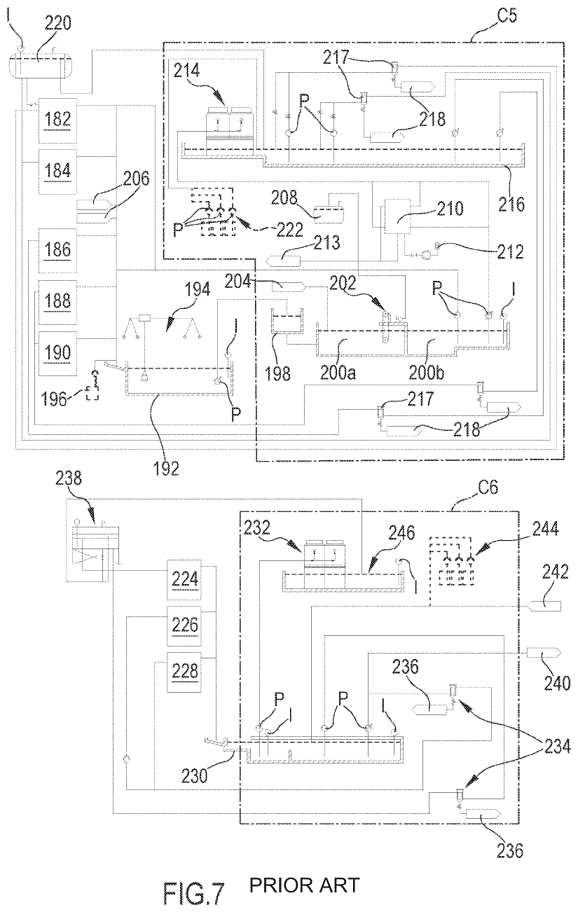

FIG. 6 represents in a flowchart the direct cooling water treatment plant according to FIG. 5 modified according to the invention. The plant is simplified as the exiting waters do not have to be cleaned separately, but they are transferred to a collecting tank with the possibility of sending them from there directly to a sheet rolling mill, a high-pressure circuit 166 and a low-pressure circuit 168. The users 134, 136 and 138 are fed, respectively, by the storage and distribution tank 154 and by a tank 170 that collects the clean and cooled waters from the plant (not represented) that treats the waters exiting the rolling mills 166 and 168. This tank is also supplied by chemical dispensers 172, make-up water 174 and is equipped with a blowdown unit 176. The tank 170, in addition to supplying the users 136 and 138 also feeds the storage and distribution tank 154, with the possibility of first passing the water through the relative self-cleaning filter units 178, the backwash water 180 can be destined to scale pits. The overall cooling water treatment circuits of FIGS. 5 and 6 are designated with C3 and C4 respectively, while the separate circuits represented in FIG. 7 below are designated with C5 and C6.

FIG. 7 represents in a flowchart the separated direct cooling water treatment plants of a steel plant for the production of long products according to the state of the art. There are several direct cooling water users: a thin strip casting machine 182, sprayers 184 thereof, a rolling mill with high-pressure circuit 186, a low-pressure circuit 188 and reheating furnaces 190. All users feed a tank 192 with bucket 194 for the elimination of scale and a dosing unit for chemical additives 196, from there the water reaches through an inlet splitter 198 a longitudinal tank 200 divided into two chambers 200a and 200b. The chamber 200a is equipped with an oil separator 202 and can also be fed with water recovered from other parts of the plant 204. Backwash waters 206 can be introduced from relative filters into the lines from the aforementioned users. From the oil separator 202, the oil reaches an oil storage 208, while from the chamber 200b the water returns into the tank 192 or it reaches, passing a sand filter 210 with blower 212 and with backwash system 213, the cooling towers 214 that release the cooled water into a longitudinal tank 216. The water can be purified by filtering it with filters 217 equipped with backwash systems 218. The filters can return the filtrate to the tank 216 or send it to the users 186, 188, 190, 184, 182 or to the storage and distribution tank which in turn feeds the user 182 or the tank 216 which can receive chemicals from the dispensers 222. A second water treatment plant C6 has three users: an accelerated cooling system 224, a side spray system 226 and a direct quenching system 228 that supply the heated cooling waters in a tank 230, from where they can be sent to the cooling towers 232, through a self-cleaning filter 234 with backwash system 236 to a piezoelectric tank 238, through a self-cleaning filter 234 with backwash system 236 to the users 226 and 228 or to a blowdown 240. Make-up water 242 is envisaged for the tank 230 as well as chemical dispensers 244. From the tank 246, the water passes into the tank 230.

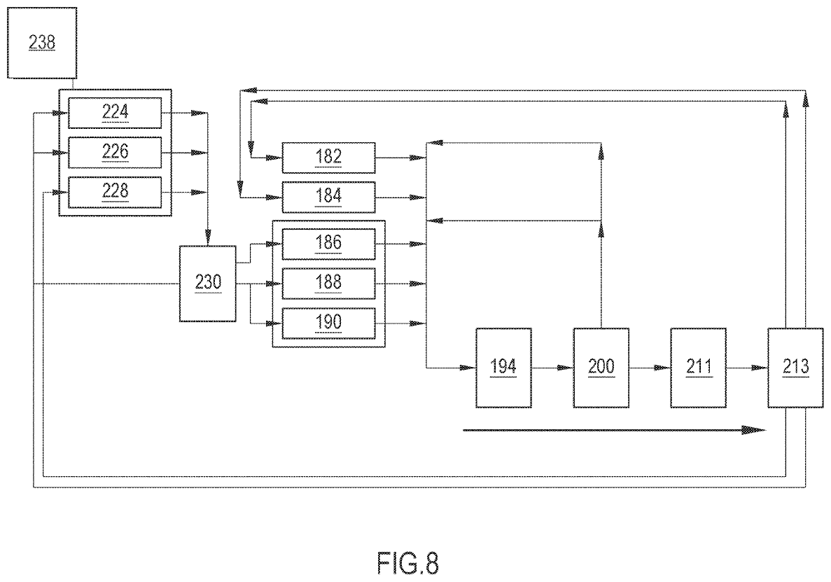

FIG. 8 represents in a simplified flowchart the union of the two cooling water treatment circuits of FIG. 7 in a single circuit according to the invention. The users 224, 226 and 228 discharge the heated cooling water directly into a tank 230 that feeds a rolling mill 226 and reheating furnaces 228 that discharge their heated waters, like the users 182 and 184 into a scale pit 194, from where they enter a clarifier 200, a battery of filters 210, and cooling towers 214. From the clarifier they can return to the scale pit to repeat the operation provided therein. The water cooled in the towers enters the users 182 and 184, the users 224, 226 and 228 or the storage and distribution tank 238 that feeds the users 224-228.

1. A steel plant for the production of long products, in particular bars, rods, profiles, wires and the like, or for flat products, in particular strips, sheets and the like comprising:
(a) a plurality of machinery equipped with direct cooling systems and divided into at least a first and a second group of machinery, each group comprising one or more pieces of machinery, wherein the groups of machinery are distinguished by the different higher or lower concentration of scale released into the cooling water accumulated during the use of each group of machinery;
(b) a circuit (C, C″, C4) of treatment of direct cooling waters exiting said direct cooling systems, comprising a plurality of cooling water treatment devices, wherein
(i) said direct cooling systems of said two groups of machinery are connected in series, wherein said direct cooling systems of said second group of machinery producing cooling waters with a higher scale concentration are situated downstream of said direct cooling systems of said first group of machinery producing cooling waters with a lower concentration of scale, so that said direct cooling systems of said first group of machinery feed said direct cooling systems of said second group of machinery; and in that
(ii) said direct cooling water treatment circuit (C, C″, C4) is arranged downstream of said second group of machinery.

2. The steel plant according to claim 1, wherein between said direct cooling systems of said first group and said direct cooling systems of said second group at least one collecting tank is provided along the water flow.

3. The steel plant according to claim 1, wherein the cooling water treatment circuit (C, C″, C4) arranged downstream of said second group of machinery comprises a succession of water treatment devices comprising, in the following order, at least one tank, preferably at least two tanks for separating scale and/or oil, said tank(s) preferably being divided into several separate chambers by means of one or more weirs, at least one filter unit and at least one cooling tower provided with at least one tank for collecting cooled water and connected to said direct cooling systems of said first group of machinery and/or, if present, to said at least one collecting tank.

4. The steel plant according to claim 1, wherein said steel plant is a plant for the production of long products, in particular bars, rods, profiles, wires and the like, and that said first group comprises at least one piece of machinery selected from the group consisting of quenching units, tempering units and that said second group comprises at least one piece of machinery selected from the group consisting of fast finishing blocks, rolling mills and reheating furnaces.

5. The steel plant according to claim 4, wherein said collection tank further feeds the at least one scale and/or oil separation tank, in particular a second scale and/or oil separation tank, preferably the most downstream chamber of the tank.

6. The steel plant according to claim 1, wherein said steel plant is a plant for producing flat products, in particular strips, sheets and the like, and that said first group of machinery comprises at least one piece of machinery selected from the group consisting of accelerated cooling units, side sweep spray units, direct quenching units, laminar cooling units, and that said second group of machinery comprises at least one piece of machinery selected from the group consisting of hot strip rolling mills and reheating furnaces.

7. A process for treating direct cooling waters of a steel plant for the production of long products, in particular bars, rods, profiles, wires and the like, or for flat products, in particular strips, sheets and the like, comprising the following steps:
(I) performing direct cooling in the steel plant resulting in the production of cooling waters rich in scale content and cooling waters less loaded with scale, depending on the machinery which make up said steel plant, which are divided into at least two groups of machinery, depending on the scale content released from the product processed by said groups of machinery into the cooling water;
(II) conveying the heated cooling water with a lower scale content exiting the respective first group of machinery to the second group of machinery of the plant which produce waters rich in scale, preferably by intermediate storage in a collecting tank;
(III) purification of the cooling waters heated and contaminated by the second group of machinery in a succession of water treatment devices comprising in the following order at least one tank, preferably at least two scale and/or oil separation tanks, at least one filtration unit and at least one cooling tower, wherein preferably under wet bulb conditions <26° C., the water is cooled to or below 30° C.;
(IV) reintroduction, at least partially, of the waters cleaned and cooled during step (III) into the direct cooling systems of said first group of machinery and/or into said collection tank, if any.

8. The process for treating direct cooling waters according to claim 7, characterized in that wherein the waters leaving the first group of machinery comprise suspended solids ≤70 mg/l, in the case of a steel plant for the production of long products, and ≤50 mg/l in the case of a steel plant for the production of flat products.

9. The process for treating direct cooling waters according to claim 7, wherein the waters exiting the first group of machinery have a ΔT with respect to the inlet temperature required by the second group of machinery which corresponds to <8° C. in the case of a steel plant for the production of long products and a ΔT of <5° C. in the case of a steel plant for the production of flat products.

10. The process for treating direct cooling waters according to claim 7, wherein the waters exiting the first group of machinery comprise only traces of oils and/or greases, in particular ≤2 mg/l of oils and/or greases.
